(19) United States
(12) Patent Application Publication
(10) Pub. No.: US 2009/0211779 A1
(43) Pub. Date: Aug. 27, 2009

(54) Electrical Box Cover With Latching Device

(75) Inventor: Mark R. Drane, Germantown, TN (US)

Correspondence Address: HOFFMANN & BARON, LLP, 6900 JERICHO TURNPIKE, SYOSSET, NY, 11791, US

(73) Assignee: THOMAS & BETTS INTERNATIONAL, INC., Wilmington, DE (US)

(21) Appl. No.: 12/365,707

(22) Filed: Feb. 4, 2009

Related U.S. Application Data
(60) Provisional application No. 61/066,836, filed on Feb. 22, 2008.

(51) Int. Cl. H02G 3/14

(52) U.S. Cl. 174/67

(57) ABSTRACT

An electrical box cover includes a housing having a base wall adapted to be attached to an electrical box. The base wall is surrounded by an outwardly extending side wall. A hood is pivotally attached to the housing and moveable between an open and closed position. A latch is selectively attachable to the side wall at one of a first and second position. The latch, when attached to said side wall, is engagable with the hood to retain the hood in the closed position.

This application claims the benefit of priority to U.S. Provisional Application No. 61/066,836 filed on Feb. 22, 2008 which is incorporated by reference herein in its entirety.

### FIELD OF INVENTION

The present invention relates to a cover for an electrical box, and more particularly, to a cover for an electrical box having a selectively positionable latch.

### BACKGROUND OF THE INVENTION

Electrical box covers are typically attached to an electrical box to enclose a receptacle, such as an electrical device or a switch, housed in the box. Covers that are designed for outdoor use typically include a lid, also referred to as a hood, which is selectively moveable between a closed and open position to provide access to the receptacle. Certain of these covers, known as while-in-use covers, provide the ability to leave an electrical plug inserted into an electrical receptacle while the lid is in the closed position. Such electrical box covers typically include a slot or notch in a side wall of the housing or in the lid in order to accommodate the cord while the lid is closed.

Electrical boxes may be mounted in a generally vertical or horizontal position. It is desirable to have the hinge at the top of the cover so that gravity will tend to move the lid into the closed position. Certain prior art covers are designed to be used only in either the horizontal or vertical orientation. Therefore, the final installation of the electrical box would dictate which cover would be used. Some covers are designed to permit mounting in both the horizontal and vertical positions. This is typically achieved by including hinges along two sides of the cover housing and along two sides of the lid. The lid may then be attached to the housing side which is positioned upwardly.

It is also desirable to include a latch near the bottom of the lid, opposite the hinge, so that the lid may be retained in the closed position. For covers that permit hinging along two sides, two latches are included. This can lead to a cover which includes extra components increasing its size and cost of manufacture.

Accordingly, it would be desirable to provide an electrical box cover which accommodates an electrical plug and cord and provides an efficient device for latching the cover in a closed position.

### SUMMARY OF THE INVENTION

The present invention provides to an electrical box cover.

The present invention further provides an electrical box cover including a hood pivotally secured to a housing.

The present invention still further relates to an electrical box cover including a hood pivotally secured to a housing and a latch selectively securable to the housing at a plurality of locations.

The present invention also provides an electrical box cover including a housing having a base wall adapted to be attached to an electrical box. The base wall is surrounded by an outwardly extending side wall. A hood is pivotally attached to the housing and moveable between an open and closed position. A latch is selectively attachable to the side wall at one of a first and second position. The latch, when attached to said side wall, is engagable with the hood to retain the hood in the closed position.

The present invention further provides an electrical box cover including a housing having a base wall and a side wall extending therefrom. A hood is pivotally secured to the housing and movable between an open and closed position. A latch is selectively securable to the housing at a plurality of positions. The latch cooperates with the hood to retain the hood in the closed position.

The present invention still further provides an electrical box cover including a housing having a base wall adapted to be attached to an electrical box. The base wall is surrounded by an outwardly extending side wall. The side wall includes a first portion and a second portion. The first and second side wall portions are angularly offset from each other. A hood is selectively pivotally attached to either of the first and second housing side wall portions. The hood is moveable between an open and closed position. A latch is selectively attachable to the side wall at one of a first and second position, the latch being engagable with the hood to retain the hood in the closed position.

### BRIEF DESCRIPTION OF THE DRAWINGS

FIG. 1 is a front perspective view of the electrical box cover of the present invention showing the cover in the horizontal position with a hood in the open position.

FIG. 2 is a front perspective view of the cover of FIG. 1 showing the cover in the vertical position.

FIG. 3 is a front perspective view of the horizontally oriented cover of FIG. 1 showing the hood in the closed position.

FIG. 4 is a front perspective view of the vertically oriented cover of FIG. 2 showing the hood in the closed position.

FIG. 5 is a side cross-sectional view showing the cover attached to an electrical box.

FIG. 6 is a top plan view of the horizontally oriented cover with the hood removed.

FIG. 7 is a top plan view of the vertically oriented cover with the hood removed.

FIG. 8 is a perspective view of a latch of the present invention.

FIG. 9 is a side perspective view of the cover showing the latch prior to attachment.

FIG. 10 is a side perspective view of the cover with the latch attached.

FIG. 11 is a detail view of the latch of FIG. 10.

FIG. 12 is top plan view of the cover with the hood in the closed and latched position.

FIG. 13 is a side elevational view of the cover of FIG. 12.

FIG. 14 is a cross-sectional view taken along line 14-14 of FIG. 12.

### DETAILED DESCRIPTION OF THE PREFERRED EMBODIMENTS:

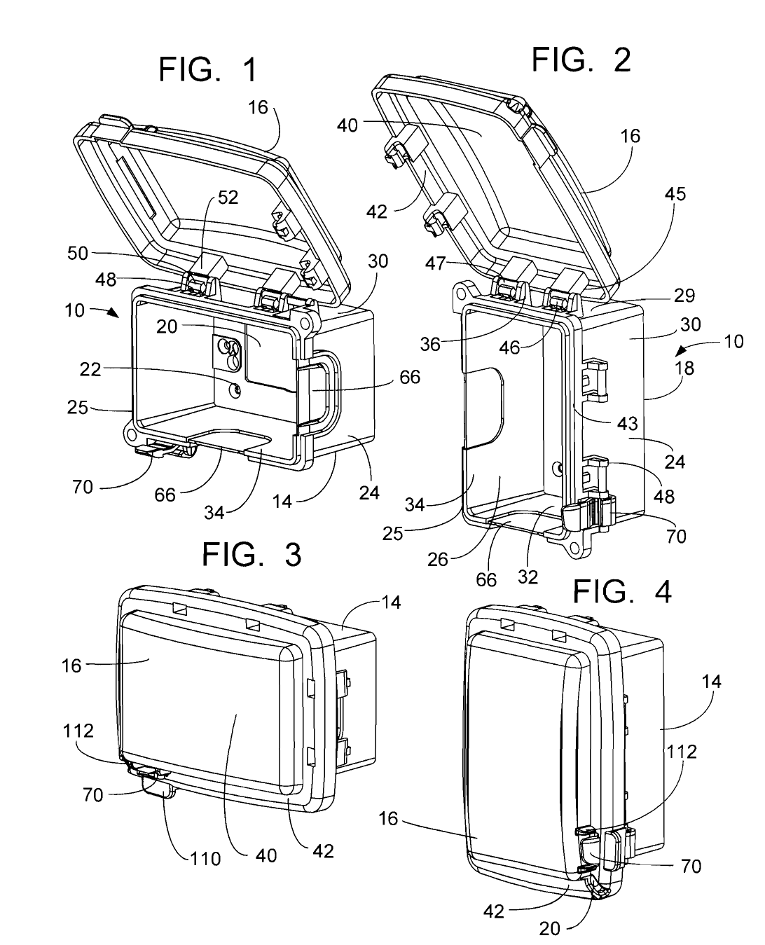

With reference to FIGS. 1-5, the present invention relates to a while-in-use electrical box cover 10 which is securable to an electrical box 12. Electrical box 12 may be an outlet box, junction box, termination box, switch box or any other type of container for housing an electrical element or terminating an electrical connection. The electrical box 12 may house an electrical receptacle 13 such as a switch or outlet.

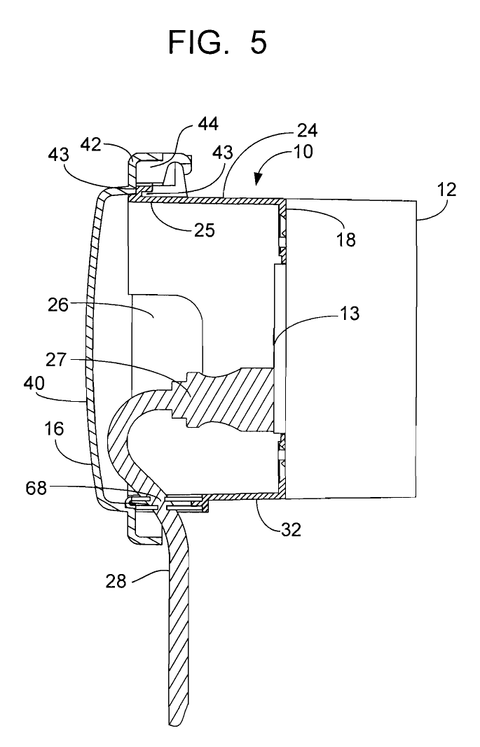

Electrical box cover 10 may include a housing 14 and a hood 16 pivotally secured thereto. The housing 14 may include a base wall 18 which includes an opening 20 there through to accommodate the electrical receptacle 13. The opening may also accommodate one or more adapter plates and/or wall plates (not shown) which are configured to accommodate different receptacles, e.g., duplex outlet, GFCI and light switch. Base wall 18 may further include through holes 22 in order to allow fastening hardware to attach the cover 10 to the electrical box 12 and/or electrical receptacles or components secured therein. The base wall 18 is perimetrically bounded by an outwardly extending side wall 24 having a front end 25. The base wall 18 and side wall 24 form a cover interior 26. The cover interior 26 may accommodate a plug 27 and a portion of its cord 28 when the hood 16 is in the closed position as shown in FIG. 5.

The electrical box cover 10 may be generally a rectangular box-like configuration having a first 29, second 30, third 32, and fourth 34 wall portions, with the first and third wall portions being shorter in length than the second and fourth wall portions. However, it is within the contemplation of the present invention that the electrical box cover 10 may be formed in a wide variety of configurations in order to accommodate various applications. Housing 14 may be formed of a plastic material or metal using processes well known in the art. The housing may further include one or more first hinge members 36 extending therefrom which cooperate with the hood 16, in a manner described in more detail below, to permit the hood to be pivotally secured to the housing.

In a preferred embodiment, hood 16 may include a central portion 40 which may be generally flat or have a curvature thereto. Bounding the perimeter of the center portion 40 is a rim 42. Rim 42 may include an L-shaped cross-sectional profile as shown in FIG. 5. It is within the contemplation of the present invention that rim 42 may be formed in a variety of configurations. The hood 16 at a position adjacent the rim 42 abuts a perimeter ledge 43 extending from the upper portion of the housing side wall 24 when the hood is in the closed position. Rim 42 further includes a recess 44, and when the hood 16 is in the closed position, the recess 44 extends around the side wall front end 25. Accordingly, the cover interior 26 and the electrical receptacle 13 are isolated from precipitation, dust and other contaminants. The hood 16 may be formed of a plastic or metallic material. When formed of plastic, the hood 16 may be transparent, translucent or opaque.

Electrical boxes 12 may be installed in a variety of orientations. Rectangular electrical boxes are typically installed in either generally vertical or horizontal orientations. In a preferred embodiment, cover 10 may be secured to an electrical box 12 in the two general positions. One position, shown for example in FIGS. 2 and 4, would be for a generally vertically positioned electrical box and the other position, shown for example in FIGS. 1 and 3, would accommodate a generally horizontally oriented electrical box.

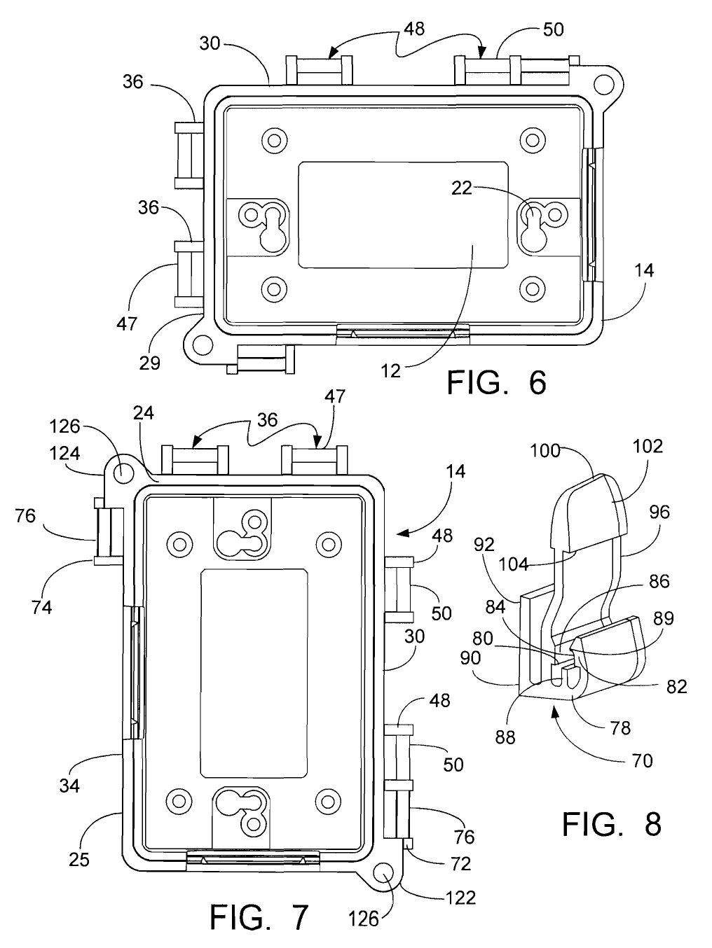

Hood 16 may be pivotally secured to the side wall 24 of the housing 14. In order to accommodate the various mounting orientations of the cover, hood 16 is preferably pivotally mountable to cover housing 14 along either one of two side wall portions. With further reference to FIGS. 2, 6 and 7, one of the side wall portions, for example the first side wall portion 29, may include the one or more housing first hinge members 36 thereon. The hinge members 36 may be spaced from each other and disposed adjacent the side wall front end 25.

With reference to FIGS. 2 and 7, the housing first hinge members 36 cooperate with hood first hinge members 45 disposed on and extending from the rim 42 of the hood. The hood first hinge members 45 may include C-shaped clips 46. Housing first hinge members 36 may include generally round posts 47 supported above the side wall 24. Clips 46 may resiliently engage and snap around posts 47 such that a rotatable connection is made. The housing first hinge members 36 and hood first hinge members 45 may be disposed along one side of their respective structures such that the hood 16 may be attached to the top of the housing 14 when the cover 10 is mounted in the vertical orientation. The clips 46 may also be removable from the posts 47 so that the hood 16 could be selectively attached and removed from the housing 14. It is also within the contemplation of the present invention that as an alternative, C-shaped clips could be mounted on the housing 14 and the posts mounted on the hood 16.

With reference to FIGS. 1, 6, and 13, the housing 14 may further include one or more housing second hinge members 48 disposed on a side wall portion adjacent the first side wall portion 29, such as second side wall portion 30. Housing second hinge members 48 may be formed including a generally round post 50 supported above the second side wall portion 30 similar to housing first hinge members 36.

As shown in FIGS. 1, and 2, hood 16 may further include hood second hinge members 52 extending from an adjacent side of the hood edge as the hood first hinge members 45. Hood second hinge members 52 may be formed similar to the hood first hinge members 45 and include clips 53. Hood second hinge members 52 may resiliently engage posts 50 of housing second hinge members 48 to form a rotatable connection. Posts 50 may include flats 55 (FIG. 13) to facilitate insertion of the clips 53 onto the posts 50. The posts 47 of the housing first hinge members 36 may also include flats thereon. This connection accommodates the cover 10 when mounted in the horizontal orientation. The resilient cooperation between the hood second hinge members 52 and the housing second hinge members 48 permits the hood to be attached and removed.

When it is desired to mount the electrical box cover 10 in a generally vertical position, hood 16 may be attached to the first side wall portion 29 through the cooperation of housing first hinge members 36 and hood first hinge members 45 as shown in FIG. 2. Alternatively, if the electrical box is desired to be mounted in a generally horizontal orientation such as that shown in FIG. 1, the hood 16 may be attached to the second wall portion 30 through the cooperation of housing second hinge members 48 and hood second hinge members 52. The mounting flexibility of the hood 16 permits the hinge to be located at the top of the cover housing 14 regardless of the orientation. Therefore, the hood will tend to fall to the closed position via gravity when left unattended.

Once the electrical box cover 10 is installed onto the electrical box 12, the plug 27 may be inserted into the receptacle 13 as shown in FIG. 5. The plug cord 28 would therefore extend out from the cover 10. In order to permit the hood 16 to be rotated to the fully closed position when the cord 28 is extending from the cover, a cord opening may be preferably provided in the housing side wall 24 or a cord opening can be provided in rim 42 of hood 16, or both. It is desirable to have the cord to extend out from the bottom of the cover. Since the cover has two different orientations, either third wall portion 32 or fourth wall portion 34 will be the bottom wall. Accordingly, in the preferred embodiment, both the third 32 and fourth 34 side wall portions include a knockout 66 formed therein (FIGS. 1 and 2). However, only one of them needs to be removed. The knockouts 66 may be formed in a manner known in the art such as by thinning the knockout or thinning material surrounding the knockout such that it is easy to remove. The knockout 66 in the third side wall portion 32 may be removed forming an opening 68 (FIG. 5) when the electrical box cover 10 is in the generally vertical direction as shown in FIG. 2. The knockout 66 on the fourth side wall portion 34 may be removed to form an opening when the electrical box is in the generally horizontal position as shown in FIG. 1. When the final orientation of the cover is determined for installation, the appropriate knockout 66 may be removed. Accordingly, no unnecessary openings need to be formed in the cover.

With reference to FIGS. 2, and 7-11, in order to retain the hood 16 in the closed position, the present invention preferably includes a latch 70. Latch 70 is preferably attached to cover housing 14, and selectively positionable thereon. Latch 70 may be selectively positioned at different locations on the housing 14 in order to accommodate the mounting orientation of the hood 16 with which it cooperates. The latch may be attached in such a manner that it may be removed after being attached. Alternatively, the attachment between the latch 70 and the housing 14 may be such that the latch cannot be removed from the housing. In this alternative embodiment, the latch could be integrally formed with the housing 14 or be attached in a manner which prevents removal.

In order to secure the latch 70 to the cover housing 14, cover housing 14 may include first and second latch keepers, 72 and 74. The first and second latch keepers may be disposed on different side wall portions. Preferably first keeper 72 is disposed on second side wall portion 30 adjacent one of the housing second hinge members 48 as shown in FIG. 7. Second keeper 74 may be disposed on fourth side wall portion 34 adjacent a corner of the housing 14. First and second keepers 72 and 74 may have a configuration similar to the housing hinge members, and include a post 76 supported above the housing side wall. The posts 76 may include a flat 77 thereon (FIG. 14.)

With specific reference to FIGS. 8 and 14, latch 70 may include a resilient clip element 78 which resiliently engages the keepers 72 and 74. Clip element 78 may include a slot 80 having a generally C-shaped cross-sectional profile as shown in FIG. 14. Bounding one side of slot 80 is a catch 82 having a longitudinally extending semicircular depression 84 which receives post 76. Disposed opposite to the catch 82 is an abutment member 86. A longitudinally extending projection 88 extends upwardly from the bottom of the slot 80. When the keeper post 76 is inserted into clip slot 80, the catch and/or abutment member 86 deflects outwardly. Once the post 76 passes into the slot 80 such that it sits within the depression 84 and against projection 88, the post is captured, as a lip 89 on the end of the catch 82 sits above flat 77.

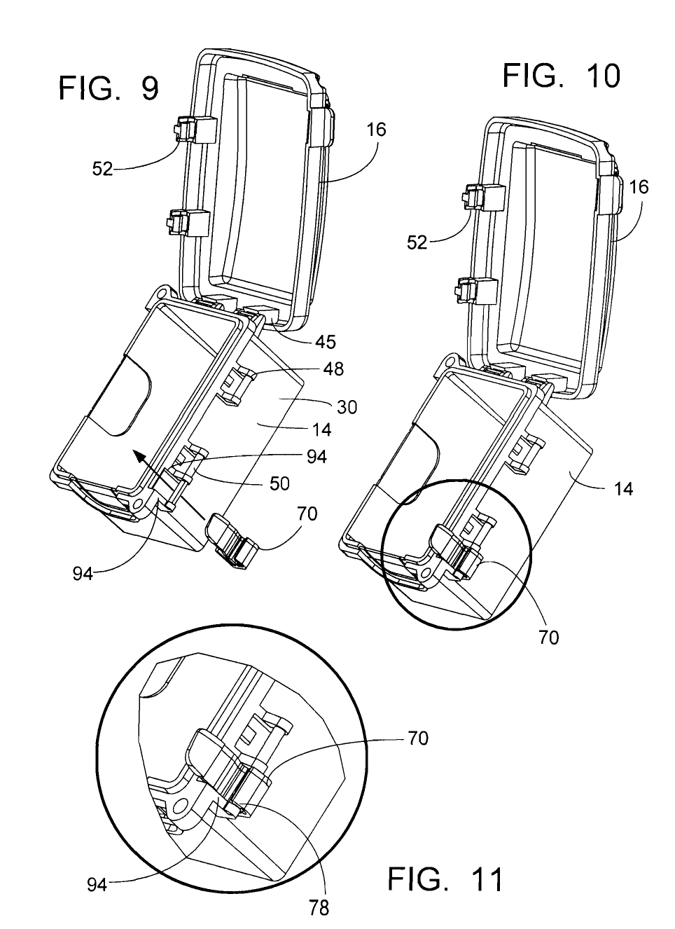

In order to install the latch 70, the latch is positioned adjacent one of the latch keepers 72, 74. Which latch keeper to choose will depend upon to which side wall the hood 16 is mounted. The latch 70 is slid along the side wall 24 in the direction shown, for example, by the arrow in FIG. 9, until the clip element 78 engages and clips onto the post 76. The latch 70 may also include a guide 90 which has a planar surface 92 that abuts the cover housing side wall 24. As shown in FIGS. 9 and 11, adjacent the keepers 72 and 74, the side wall 24 may include spaced ridges 94 between which the guide 90 extends. Guide 90 helps the latch 70 to be properly positioned with respect to the side wall and latch keeper so that the latch 70 can be clipped to the keeper (72, 74) as shown in FIGS. 9 and 10. It is within the contemplation of the present invention that the latch 70 could be formed having other configurations.

With reference to FIG. 8, latch 70 further includes a resilient hood engaging element 96 extending upwardly from clip element 78. Hood engaging element 96 extends through an opening 98 in hood 16 when the hood is in the closed position as shown in FIGS. 2 and 14. A hood engaging element distal end 100 may include a curved surface 102 and lip 104. Upon closing of the hood 16, the curved surface 102 engages a ramped structure 106 on the hood causing the hood engaging element 96 to deflect and extend through the hood opening 98. When the lip 104 extends past the hood opening 98, the hood engaging element 96 snaps back or returns to its original position to engage and retain the hood 16. To open the hood 16, a user may urge the distal end 100 toward the side wall thereby clearing it from the edges of opening 98. The hood 16 may then be pivoted to the open position.

The latch 70 may be removed from the housing 14 after being attached so that its location on the housing may be changed as desired. In order to remove the latch 70, the clip element 78 may be deflected to disengage the post 76 and the latch can then be slid away from the housing. When the hood 16 is mounted in the vertical position, the latch 70 may be attached to the first keeper 72 disposed on the second side wall portion 30. When the hood 16 is mounted in the horizontal position as shown in FIG. 1, the latch 70 may be attached to the second keeper 74 located on the fourth side wall portion 34. Accordingly, the latch 70 is selectively positionable on cover housing 14 so that it is properly aligned with the hood opening 98 whether the hood 16 is mounted in the vertical or horizontal orientation.

Referring to FIGS. 3 and 14, hood 16 may include a lift tab 110 adjacent opening 98 to assist a user in moving the cover between the open and closed positions. Hood 16 may also include a pair of spaced ribs 112 positioned adjacent the opening 98. Ribs 112 act as a guard to protect the hood engagement element 96 from impact when the hood 16 is in the closed position.

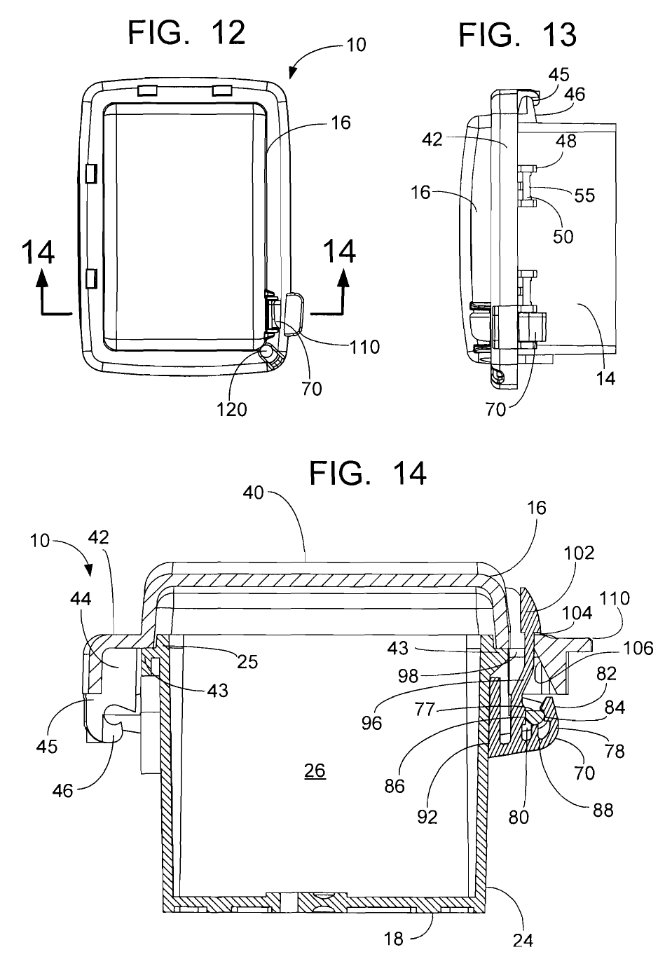

It may be desirable to lock the hood 16 in the closed position such that access to the interior is restricted. Accordingly, hood 16 may include a lock opening 120 (FIG. 12) in a corner thereof. With reference to FIG. 7, the cover housing 14 may include a first and second lug 122, 124 extending from opposed corners of the housing adjacent the side wall front end 25. The lugs 122 and 124 may each include an opening 126 there-through. When the hood is attached to the housing 14 when in the vertical orientation, the lock opening 120 aligns with the opening in lug 122. When the hood 16 is mounted on the housing in the horizontal position, the lock opening 120 aligns with the opening in lug 124. A lock or securement band (not shown) may be placed through the aligned openings 120 and 126 to keep the hood 16 secured in the closed position.

When the hood 16 is in the closed position, its rim 42 extends beyond the front end of the housing side wall 25 as shown in FIG. 13. Therefore, the hood 16 obscures the housing hinge members and lugs 122, 124 when viewed from the front, such as in FIG. 12. Additionally, the hood hinge members preferably do not extend beyond the perimeter of the rim when viewed from the front of the cover. Accordingly, no obstructions are created beyond the perimeter of the hood rim.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. An electrical box cover comprising:
a housing including a base wall adapted to be attached to an electrical box, said base wall being surrounded by an outwardly extending side wall;
a hood pivotally attached to said housing and moveable between an open and closed position; and
a latch selectively attachable to said side wall at one of a first and second position, said latch when attached to said side wall being engagable with said hood to retain said hood in said closed position.

2. The cover as defined in claim 1, wherein said side wall includes a first portion and a second portion and said first portion includes a first keeper for securing said latch thereto and said second portion includes a second keeper for securing said latch thereto.

3. The cover as defined in claim 3, wherein said latch includes a clip for attaching said latch to one of said first and second keepers.

4. The cover as defined in claim 3, wherein said clip permits said latch to be removably secured to said side wall.

5. The cover as defined in claim 1, wherein said latch includes a hood engaging portion for resiliently engaging said hood.

6. The cover as defined in claim 4, wherein said first latch keeper includes a post and said clip includes a slot, said clip reliantly engages said post to retain said post in said slot.

7. The cover as defined in claim 1, wherein said cover housing includes a first hinge member disposed on a first side wall portion and a second hinge member disposed on a second side wall portion.

8. The cover as defined in claim 7, wherein said first side wall portion and said second side wall portion adjoin each other.

9. The cover as defined in claim 7, wherein said hood is selectively attachable to one of said first and second hinge members.

10. An electrical box cover comprising:
a housing having a base wall and a side wall extending therefrom;
a hood pivotally secured to said housing and movable between an open and closed position;
a latch selectively attachable to said housing at a plurality of positions, said latch cooperating with said hood to retain said hood in said closed position.

11. The cover as defined in claim 10, wherein a latch is removably secured to said housing.

12. The cover as defined in claim 10, wherein said hood is pivotably attachable to said housing at one of a first and a second position.

13. The cover as defined in claim 12, wherein a positioning of said latch on said housing is dependant on a positioning of said hood on said housing.

14. The cover as defined in claim 10, wherein said latch includes a clip engagable said housing

15. The cover as defined in claim 14, wherein said latch includes a hood engaging element extending from said clip, said hood engaging element resiliently engaging said hood when in said closed position for retaining said hood in said closed position.

16. An electrical box cover comprising:
a housing including a base wall adapted to be attached to an electrical box, said base wall being surrounded by an outwardly extending side wall, said side wall including a first portion and a second portion, said first and second side wall portions being angularly offset from each other;
a hood selectively pivotally attached to either of said first and said second housing side wall portions, said hood being moveable between an open and closed position; and
a latch selectively attachable to said side wall at one of a first and second position, said latch being engagable with said hood to retain said hood in said closed position.

17. The cover as defined in claim 16, wherein said latch is attachable to said side wall at said first position when said hood is pivotally attached to said first wall portion.

18. The cover as defined in claim 16, wherein said latch is attachable to said side wall at said second position when said hood is pivotally attached to said second wall portion.

19. The cover as defined in claim 16, wherein said latch includes a resilient clip engagable with said housing for removably securing said latch thereto.

20. The cover as defined in claim 16, wherein said housing side wall first portion is generally 90 degrees offset from said housing second side wall portion.
